(19) United States
(12) Patent Application Publication
(10) Pub. No.: US 2025/0306533 A1
(43) Pub. Date: Oct. 2, 2025

(54) TIMEPIECE

(71) Applicant: SEIKO WATCH KABUSHIKI KAISHA (trading as SEIKO WATCH CORPORATION), Tokyo (JP)

(72) Inventors: Satoshi SAKAI, Tokyo (JP); Kosuke YAMAMOTO, Tokyo (JP); Kenji OGASAWARA, Tokyo (JP); Kazumi SAKUMOTO, Tokyo (JP)

(21) Appl. No.: 19/084,173

(22) Filed: Mar. 19, 2025

(30) Foreign Application Priority Data
Mar. 28, 2024 (JP) 2024-052774

(51) Int. Cl. G04B 25/02

(52) U.S. Cl. CPC G04B 25/02

(57) ABSTRACT

Provided is a timepiece capable of preventing a deviation in an indication time when a user recognizes a time indication by touching with a finger. A timepiece includes: a dial having an indication region that is able to be exposed to outside and including a plurality of indexes that are able to be recognized with a tactile sense on the indication region; and one or more indication plates configured to rotate around a rotation shaft orthogonal to the indication region. Indicators indicating a time are formed on front surfaces of the indication plates by unevenness that is able to be recognized by finger touch.

### RELATED APPLICATIONS

This application claims priority to Japanese Patent application No. JP2024-052774, filed on Mar. 28, 2024, the entire content of which is incorporated herein by reference.

### BACKGROUND OF THE INVENTION

### 1. Field of the Invention

The present invention relates to a timepiece.

### 2. Description of Related Art

A timepiece for a visually impaired person (for example, a weak eyesight person and a totally blind person) includes, for example, a timepiece mechanism including a time indication (an hour hand and a minute hand), and an opening and closing lid that covers the time indication in an openable and closable manner (for example, see PTL 1). In this timepiece, a user opens the opening and closing lid to cause the hour hand and the minute hand to expose, and touches the hour hand and the minute hand with a finger, whereby an indicated time can be recognized.

### 3. Citations

### Patent Literature

PTL 1: JPH09-264967A

### SUMMARY OF THE INVENTION

In the timepiece, the hour hand or the minute hand may receive a large force in a rotation direction when the user touches the hour hand or the minute hand with a finger to recognize a time. In this case, an excessive torque is applied to a rotation shaft, and the accuracy of the indication time may be reduced.

An object of an aspect of the invention is to provide a timepiece capable of preventing a deviation in an indication time when a user recognizes a time indication by touching with a finger.

[1] A timepiece includes: a dial having an indication region that is able to be exposed to outside and including a plurality of indexes that are able to be recognized with a tactile sense on the indication region; and one or more indication plates configured to rotate around a rotation shaft orthogonal to the indication region. An indicator indicating a time is formed on a front surface of the indication plate by unevenness that is able to be recognized by finger touch.

According to the timepiece, since the indicator is formed on the front surface of the indication plate, when the user touches and recognizes the indicator with fingers, a force in a circumferential direction applied to the indication plate can be reduced. Accordingly, it is possible to prevent inaccuracy of an indication time (that is, a deviation of the indication time) caused by application of an excessive torque to the indication plate.

[2] In the timepiece according to [1], a plurality of the indication plates are provided, and the plurality of indication plates include an hour indication plate including, as the indicator, an hour indicator indicating an hour of the time, and a minute indication plate including, as the indicator, a minute indicator indicating a minute of the time.

In the timepiece, the hour and the minute of the time can be recognized. Accordingly, a detailed time can be recognized.

[3] In the timepiece according to [2], the hour indicator and the minute indicator are formed in a range in which the hour indicator and the minute indicator are able to be simultaneously recognized by finger touch with one finger.

In the timepiece, the hour indicator and the minute indicator can be simultaneously recognized by finger touch. Accordingly, an operation of recognizing a time is facilitated.

In the timepiece, since the hour indicator and the minute indicator can be easily recognized by the finger, a force in a circumferential direction is hardly applied to the indication plate. Accordingly, when the user recognizes an indicator by touching the indicator with a finger, it is possible to prevent inaccuracy of an indication time (that is, a deviation of the indication time).

[4] In the timepiece according to any one of [1] to [3], at least one of the dial and the indication plate is formed with a protrusion for restricting tilting of the indication plate adjacent thereto.

In the timepiece, it is possible to restrict the tilting of the indication plate and stabilize a posture thereof. Accordingly, when the user recognizes an indicator by touching the indicator with a finger, it is possible to prevent inaccuracy of an indication time (that is, a deviation of the indication time).

[5] In the timepiece according to any one of [1] to [4], at least one of the dial and the indication plate has a restriction portion, which is close to the indication plate adjacent thereto and which restricts tilting of the indication plate.

In the timepiece, it is possible to restrict the tilting of the indication plate and stabilize a posture thereof. Accordingly, when the user recognizes an indicator by touching the indicator with a finger, it is possible to prevent inaccuracy of an indication time (that is, a deviation of the indication time).

[6] In the timepiece according to any one of [1] to [5], at least a part of a pair of side surfaces of the indicator is inclined so as to approach each other as a protrusion height thereof increases.

In the timepiece, when the user touches the indicator with a finger, the finger is less likely to be locked. Therefore, a force in a circumferential direction applied to the indication plate can be reduced. Accordingly, when the user recognizes an indicator by touching the indicator with a finger, it is possible to prevent inaccuracy of an indication time (that is, a deviation of the indication time).

[7] In the timepiece according to any one of [1] to [6], the indicator is formed by a plurality of dot-shaped protrusions.

In the timepiece, when the user touches the indicator with a finger, the finger is less likely to be locked. Therefore, a force in a circumferential direction applied to the indication plate can be reduced. Accordingly, when the user recognizes an indicator by touching the indicator with a finger, it is possible to prevent inaccuracy of an indication time (that is, a deviation of the indication time).

[8] In the timepiece according to any one of [1] to [7], a bearing tube portion through which the rotation shaft is inserted protrudes and is formed on the indication plate.

In the timepiece, a frictional force between the rotation shaft and the indication plate can be increased. Therefore, an attachment strength of the indication plate to the rotation shaft can be increased. Accordingly, when the user recognizes an indicator by touching the indicator with a finger, it is possible to prevent inaccuracy of an indication time (that is, a deviation of the indication time).

[9] In the timepiece according to any one of [1] to [8], the rotation shaft has a non-circular cross section perpendicular to a length direction thereof, and the indication plate has a fitting hole into which the rotation shaft is press-fitted.

In the timepiece, an attachment strength of the indication plate to the rotation shaft can be increased. Accordingly, when the user recognizes an indicator by touching the indicator with a finger, it is possible to prevent inaccuracy of an indication time (that is, a deviation of the indication time).

In the timepiece according to any one of [1] to [9], the indication plate is formed in a circular plate shape concentric with the rotation shaft.

In the timepiece, when the user touches and recognizes the indicator with a finger, a force in a circumferential direction applied to the indication plate can be reduced.

According to an aspect of the invention, it is possible to prevent a deviation in an indication time when the user recognizes a time indication by touching with a finger.

### BRIEF DESCRIPTION OF THE DRAWINGS

FIG. 1 is a schematic diagram of a timepiece according to a first embodiment.

FIG. 2 is a schematic diagram showing a cross section of a dial and an indication plate of the timepiece according to the first embodiment.

FIG. 3 is a schematic diagram of a timepiece according to a second embodiment.

FIG. 4 is a schematic diagram showing a cross section of a dial and an indication plate of a timepiece according to a third embodiment.

FIG. 5 is a plan view of a first example of a first restriction protrusion.

FIG. 6 is a plan view of a second example of the first restriction protrusion.

FIG. 7 is a schematic diagram showing a cross section of a dial and an indication plate of a timepiece according to a fourth embodiment.

FIGS. 8A and 8B are a plan view and a side view of the indication plate including a first example of an indicator.

FIG. 9 is a side view of the indication plate including a second example of an indicator.

FIG. 10 is a side view of the indication plate including a third example of an indicator.

FIG. 11 is a plan view of the indication plate including a fourth example of an indicator.

FIG. 12 is a schematic diagram showing a cross section of a dial and an indication plate of a timepiece according to a fifth embodiment.

FIG. 13 is a schematic perspective view of a dial and an indication plate of a timepiece according to a sixth embodiment.

FIG. 14 is a schematic diagram showing a method of assembling the dial and the indication plate of the timepiece according to the sixth embodiment.

### DETAILED DESCRIPTION OF THE PREFERRED EMBODIMENTS

Hereinafter, embodiments of the invention will be described with reference to the drawings.

### Timepiece

### First Embodiment

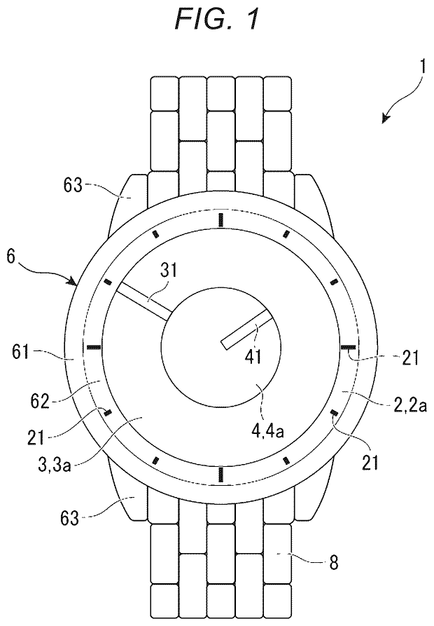

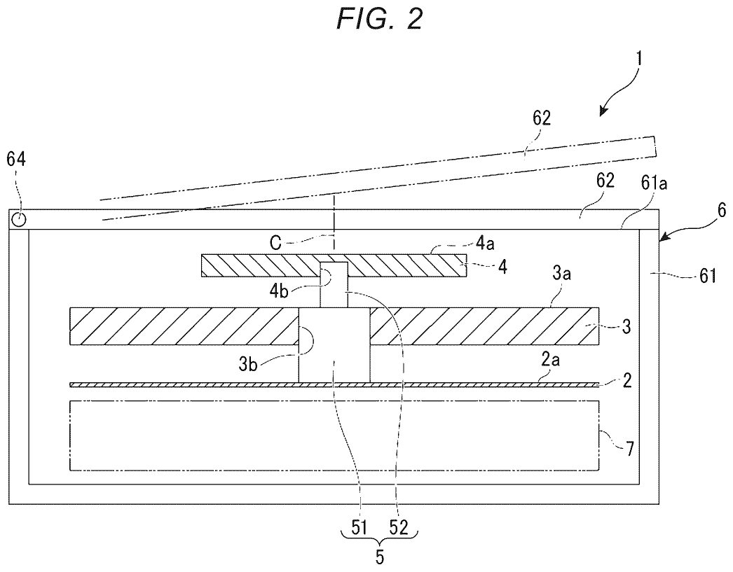

FIG. 1 is a schematic diagram of a timepiece 1 according to a first embodiment. FIG. 2 is a schematic diagram showing a cross section of a dial 2 and indication plates 3 and 4 of the timepiece 1.

A vertical posture of the timepiece 1 is temporarily defined according to FIG. 2. In FIG. 2, a rotation shaft 5 protrudes upward from the dial 2. The minute indication plate 4 is positioned above the hour indication plate 3. An upper side of the timepiece 1 is a side from which the user visually recognizes the timepiece 1, and is also referred to as a front side. A lower side of the timepiece 1 is also referred to as a back side. A central axis C of the rotation shaft 5 is parallel to a vertical direction. The posture of the timepiece 1 defined here does not limit a posture of the timepiece 1 during use. A “circumferential direction” is a direction around the central axis C. A “radial direction” is a direction orthogonal to the central axis C and passing through the central axis C. A “plan view” is a view from the vertical direction.

As shown in FIG. 1, the timepiece 1 includes the dial 2, the hour indication plate 3 (indication plate), the minute indication plate 4 (indication plate), the rotation shaft 5 (see FIG. 2), a case 6, and a movement 7 (see FIG. 2).

As shown in FIG. 2, the case 6 includes a case body 61, a windshield glass 62 (lid), and two strap attachment portions 63 (see FIG. 1). The case body 61 has, for example, a bottomed cylindrical shape. The windshield glass 62 is hinged to the case body 61 via a hinge portion 64. The windshield glass 62 openably and closably closes an upper end opening portion 61a of the case body 61. The windshield glass 62 is transparent. The dial 2, the hour indication plate 3, and the minute indication plate 4 are visible through the windshield glass 62.

The case 6 houses the dial 2, the hour indication plate 3, the minute indication plate 4, the rotation shaft 5, and the movement 7.

As shown in FIG. 1, a strap 8 is attached to the strap attachment portion 63.

As shown in FIG. 2, the dial 2 is formed in, for example, a circular plate shape concentric with the rotation shaft 5. An upper surface (a surface on the front side) of the dial 2 is an indication region 2a. The indication region 2a can be exposed to the outside. For example, the indication region 2a is exposed to the outside by opening the windshield glass 62.

As shown in FIG. 1, a plurality of indexes 21 are formed in the indication region 2a. The plurality of indexes 21 are arranged at intervals in the circumferential direction. The indexes 21 are formed in an annular region on an outer side of the hour indication plate 3 in the indication region 2a in a plan view. The indexes 21 can be touched by a finger of the user. The indexes 21 are visible in the plan view.

The indexes 21 are formed in the indication region 2a by unevenness that can be recognized by finger touch. The “unevenness” is at least one of a protrusion portion and a recessed portion. The indexes 21 are formed by, for example, a protrusion portion protruding upward from the indication region 2a. The “can be recognized by finger touch” means that the user can recognize the indexes 21 by touching with a finger. The shape of the indexes 21 may be, for example, a linear shape or a dot shape along the radial direction.

In the embodiment, the twelve indexes 21 are formed in the indication region 2a and have equal pitches (30° pitch) in the circumferential direction. The twelve indexes 21 are formed, for example, at positions of 1 o'clock to 12 o'clock, respectively. The indexes 21 formed at the positions of 3 o'clock, 6 o'clock, 9 o'clock, and 12 o'clock have a dimension in the radial direction larger than that of the other indexes 21.

As shown in FIG. 2, the rotation shaft 5 protrudes upward from a center of the indication region 2a of the dial 2. The central axis C of the rotation shaft 5 is orthogonal to the indication region 2a.

The rotation shaft 5 includes a first rotation shaft 51 and a second rotation shaft 52. The first rotation shaft 51 protrudes upward from the indication region 2a. The first rotation shaft 51 has, for example, a cylindrical shape. The first rotation shaft 51 rotates around the central axis C by the movement 7.

The second rotation shaft 52 protrudes upward from the indication region 2a. The second rotation shaft 52 has, for example, a cylindrical shape coaxial with the first rotation shaft 51. An outer diameter of the second rotation shaft 52 is smaller than an outer diameter of the first rotation shaft 51. The second rotation shaft 52 rotates around the central axis C by the movement 7. A protrusion height of the second rotation shaft 52 is higher than a protrusion height of the first rotation shaft 51.

As shown in FIG. 1, the hour indication plate 3 is formed in, for example, a circular plate shape concentric with the rotation shaft 5. The hour indication plate 3 is disposed parallel to the indication region 2a. The hour indication plate 3 is provided at a position separated upward from the dial 2. An outer diameter of the hour indication plate 3 is smaller than an outer diameter of the dial 2.

As shown in FIG. 2, the hour indication plate 3 has a fitting hole 3b into which the first rotation shaft 51 is fitted. When the first rotation shaft 51 is fitted into the fitting hole 3b, the hour indication plate 3 is attached to the first rotation shaft 51. The hour indication plate 3 rotates in the circumferential direction by rotational drive of the first rotation shaft 51.

As shown in FIG. 1, an hour indicator 31 is formed on a front surface 3a (an upper surface, a surface on the front side) of the hour indication plate 3. At least a part of the hour indicator 31 is formed in an annular region on an outer side of the minute indication plate 4 on the front surface 3a in the plan view. The hour indicator 31 can be touched by a finger of the user. The hour indicator 31 is visible in the plan view.

The hour indicator 31 may be formed integrally with the hour indication plate 3. The hour indicator 31 may be provided separately from the hour indication plate 3 and attached to the front surface 3a by adhesion or the like.

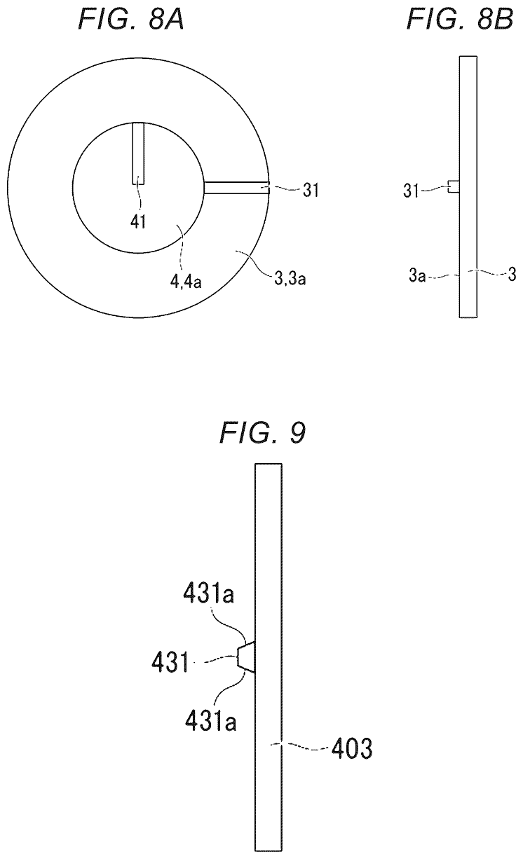

The hour indicator 31 is formed on the front surface 3a by unevenness that can be recognized by finger touch (see FIG. 8). The hour indicator 31 is formed by, for example, a protrusion portion protruding upward from the front surface 3a. A shape of the hour indicator 31 may be, for example, a linear shape or a dot shape along the radial direction. In the embodiment, the hour indicator 31 is a protrusion portion extending linearly along the radial direction. An outer end of the hour indicator 31 in the radial direction reaches an outer peripheral edge of the hour indication plate 3. An inner end of the hour indicator 31 in the radial direction is positioned close to an outer peripheral edge of the minute indication plate 4 in the plan view.

The hour indicator 31 indicates a time. Specifically, the hour indicator 31 is an indicator indicating an “hour” of the time. For example, the hour indication plate 3 makes one rotation in 12 hours. The hour indicator 31 moves 30° in the circumferential direction per hour.

The minute indication plate 4 is formed in, for example, a circular plate shape concentric with the rotation shaft 5. The minute indication plate 4 is disposed parallel to the indication region 2a. The minute indication plate 4 is provided at a position separated upward from the hour indication plate 3. An outer diameter of the minute indication plate 4 is smaller than the outer diameter of the hour indication plate 3.

As shown in FIG. 2, the minute indication plate 4 has a fitting hole 4b into which the second rotation shaft 52 is fitted. When the second rotation shaft 52 is fitted into the fitting hole 4b, the minute indication plate 4 is attached to the second rotation shaft 52. The minute indication plate 4 rotates in the circumferential direction by rotational drive of the second rotation shaft 52.

As shown in FIG. 1, a minute indicator 41 is formed on a front surface 4a (an upper surface, a surface on the front side) of the minute indication plate 4. The minute indicator 41 can be touched by a finger of the user. The minute indicator 41 is visible in the plan view.

The minute indicator 41 may be formed integrally with the minute indication plate 4. The minute indicator 41 may be provided separately from the minute indication plate 4 and attached to the front surface 4a by adhesion or the like.

The minute indicator 41 is formed on the front surface 4a by unevenness that can be recognized by finger touch. The minute indicator 41 is formed by, for example, a protrusion portion protruding upward from the front surface 4a. A shape of the minute indicator 41 may be, for example, a linear shape or a dot shape along the radial direction. In the embodiment, the minute indicator 41 is a protrusion portion extending linearly along the radial direction. An outer end of the minute indicator 41 in the radial direction reaches an outer peripheral edge of the minute indication plate 4. An inner end of the minute indicator 41 in the radial direction is positioned at a center of the minute indication plate 4 in the plan view.

The minute indicator 41 indicates a time. Specifically, the minute indicator 41 is an indicator indicating a “minute” of the time. For example, the minute indication plate 4 makes one rotation in 60 minutes. The minute indicator 41 moves 30° in the circumferential direction in 5 minutes.

### Method of Using Timepiece

As shown in FIG. 2, the windshield glass 62 (lid) is opened, so that the dial 2, the hour indication plate 3, and the minute indication plate 4 are exposed to the outside. Accordingly, the indexes 21, the hour indicator 31, and the minute indicator 41 can be touched with a finger. The user can touch the indexes 21, the hour indicator 31, and the minute indicator 41 with the finger to recognize the positions in the circumferential direction. The user can recognize the time (for example, the current time) by comparing the positions of the hour indicator 31 and the minute indicator 41 with the positions of the indexes 21.

In the timepiece 1, since the indicated time can be read by a tactile sense, a visually impaired person (for example, a weak eyesight person and a totally blind person) can be assumed as the user.

### Effects of Timepiece in Embodiment

The timepiece 1 according to the embodiment includes the indication plates 3 and 4 (the hour indication plate 3 and the minute indication plate 4). On the front surfaces 3a and 4a of the indication plates 3 and 4, the indicators 31 and 41 (the hour indicator 31 and the minute indicator 41) indicating the time are formed, respectively. Since the indicators 31 and 41 are formed on the front surfaces 3a and 4a of the indication plates 3 and 4, when the user touches and recognizes the indicators 31 and 41 with fingers, a force in the circumferential direction applied to the indication plates 3 and 4 can be reduced. Accordingly, it is possible to prevent inaccuracy of the indication time (that is, a deviation of the indication time) caused by application of an excessive torque to the indication plates 3 and 4.

On the other hand, in a timepiece that indicates a time using an hour hand and a minute hand, when a user touches the hour hand and the minute hand with a finger to recognize the time, a large force in the circumferential direction is applied to the hour hand and the minute hand, and the accuracy of the indication time may be reduced.

The timepiece 1 includes the hour indication plate 3 having the hour indicator 31 and the minute indication plate 4 having the minute indicator 41. Therefore, the hour and the minute of the time can be recognized. Accordingly, a detailed time can be recognized.

Since the indication plates 3 and 4 (the hour indication plate 3 and the minute indication plate 4) each have a circular plate shape, the force in the circumferential direction applied to the indication plates 3 and 4 can be reduced when the user touches and recognizes the indicators 31 and 41 with fingers.

### Timepiece

### Second Embodiment

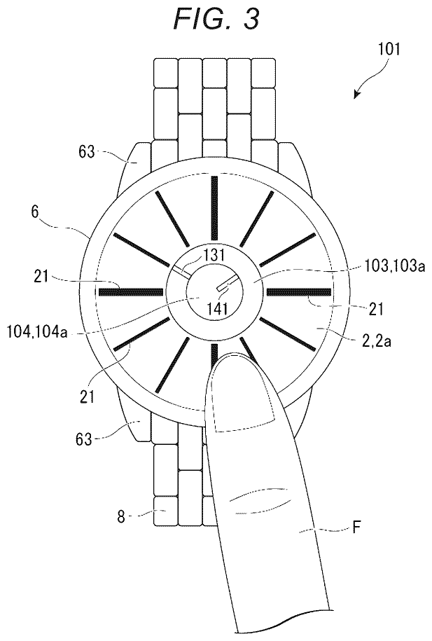

FIG. 3 is a schematic diagram of a timepiece 101 according to a second embodiment. Components common to the other embodiments are denoted by the same reference numerals, and the description thereof is omitted.

As shown in FIG. 3, the timepiece 101 is different from the timepiece 1 (see FIG. 1) according to the first embodiment in that an hour indication plate 103 is used instead of the hour indication plate 3 and a minute indication plate 104 is used instead of the minute indication plate 4. The timepiece 101 may have the same configuration as the timepiece 1 (see FIG. 1) except for the hour indication plate 103 and the minute indication plate 104.

An hour indicator 131 is formed on a front surface 103a (an upper surface, a surface on a front side) of the hour indication plate 103. The hour indicator 131 is formed by unevenness that can be recognized by finger touch.

An outer diameter ratio of the hour indication plate 103 (a ratio of an outer diameter of the hour indication plate 103 to the outer diameter of the dial 2) is smaller than an outer diameter ratio of the hour indication plate 3 in the timepiece 1 (see FIG. 1). The outer diameter ratio of the hour indication plate 103 is, for example, 50% or less.

A minute indicator 141 is formed on a front surface 104a (an upper surface, a surface on a front side) of the minute indication plate 104. The minute indicator 141 is formed by unevenness that can be recognized by finger touch.

An outer diameter ratio of the minute indication plate 104 (a ratio of an outer diameter of the minute indication plate 104 to the outer diameter of the dial 2) is smaller than an outer diameter ratio of the minute indication plate 4 in the timepiece 1 (see FIG. 1). The outer diameter ratio of the minute indication plate 104 is, for example, 30% or less.

The hour indicator 131 and the minute indicator 141 are formed in a range in which the hour indicator 131 and the minute indicator 141 can be simultaneously recognized by finger touch with one finger F of a user. Specifically, the hour indicator 131 and the minute indicator 141 are within a range that can be touched with the finger F at a time.

### Effects of Timepiece in Embodiment

The timepiece 101 according to the embodiment achieves the same effects as the timepiece 1 according to the first embodiment.

Further, in the timepiece 101, the hour indicator 131 and the minute indicator 141 are formed in a range in which the hour indicator 131 and the minute indicator 141 can be simultaneously recognized by finger touch with one finger F of the user. Therefore, the hour indicator 131 and the minute indicator 141 can be simultaneously recognized by finger touch. Accordingly, an operation of recognizing a time is facilitated.

In the timepiece 101, since the hour indicator 131 and the minute indicator 141 can be easily recognized by the finger F, a force in the circumferential direction is hardly applied to the indication plates 103 and 104. Accordingly, when the user recognizes an indicator by touching the indicator with a finger, it is possible to prevent inaccuracy of an indication time (that is, a deviation of the indication time).

### Timepiece

### Third Embodiment

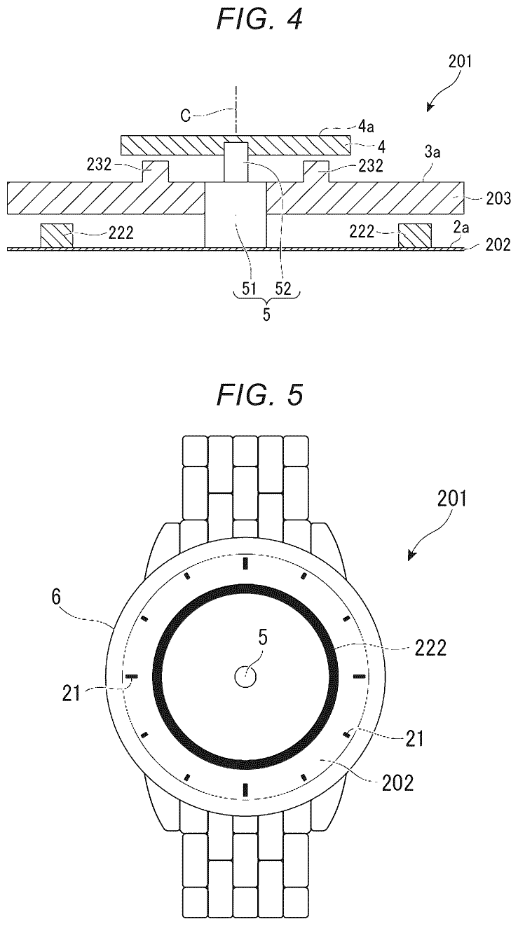

FIG. 4 is a schematic diagram showing a cross section of a dial 202 and indication plates 203 and 4 of a timepiece 201 according to a third embodiment. FIG. 5 is a plan view of a first example of a first restriction protrusion 222. FIG. 6 is a plan view of a second example of the first restriction protrusion 222. Components common to the other embodiments are denoted by the same reference numerals, and the description thereof is omitted.

As shown in FIG. 4, the timepiece 201 is different from the timepiece 1 according to the first embodiment (see FIG. 2) in that the first restriction protrusion 222 (protrusion) is formed in the indication region 2a of the dial 202, and a second restriction protrusion 232 (protrusion) is formed on the front surface 3a of the hour indication plate 203. The timepiece 201 may have the same configuration as the timepiece 1 (see FIG. 2) except for the first restriction protrusion 222 and the second restriction protrusion 232.

The first restriction protrusion 222 protrudes upward from the indication region 2a of the dial 202. A shape of a cross section of the first restriction protrusion 222 orthogonal to a length direction thereof is, for example, a rectangular shape. The first restriction protrusion 222 can have a circular ring shape concentric with the dial 202 in a plan view (see FIG. 5). The first restriction protrusion 222 can be formed by a plurality of protrusion portions 223 arranged in a circular ring shape (see FIG. 6).

The first restriction protrusion 222 is formed at a position overlapping the hour indication plate 203 in the plan view. A protrusion height of the first restriction protrusion 222 from the indication region 2a is set to such an extent that the first restriction protrusion 222 does not reach the hour indication plate 203. When the hour indication plate 203 is tilted, the hour indication plate 203 comes into contact with the first restriction protrusion 222. Therefore, the first restriction protrusion 222 can restrict tilting of the hour indication plate 203.

The second restriction protrusion 232 protrudes upward from the front surface 3a of the hour indication plate 203. A shape of a cross section of the second restriction protrusion 232 orthogonal to the length direction thereof is, for example, a rectangular shape. The second restriction protrusion 232 may be formed in a circular ring shape concentric with the hour indication plate 203 in the plan view, or may be formed by a plurality of protrusion portions arranged in a circular ring shape.

The second restriction protrusion 232 is formed at a position overlapping the minute indication plate 4 in the plan view. A protrusion height of the second restriction protrusion 232 from the front surface 3a is set to such an extent that the second restriction protrusion 232 does not reach the minute indication plate 4. When the minute indication plate 4 is tilted, the minute indication plate 4 comes into contact with the second restriction protrusion 232. Therefore, the second restriction protrusion 232 can restrict tilting of the minute indication plate 4.

### Effects of Timepiece in Embodiment

The timepiece 201 according to the embodiment achieves the same effects as the timepiece 1 according to the first embodiment.

Further, in the timepiece 201, the tilting of the hour indication plate 203 can be prevented by the first restriction protrusion 222. The tilting of the minute indication plate 4 can be prevented by the second restriction protrusion 232. Therefore, postures of the hour indication plate 203 and the minute indication plate 4 can be stabilized. Accordingly, when the user recognizes an indicator by touching the indicator with a finger, it is possible to prevent inaccuracy of an indication time (that is, a deviation of the indication time).

In the timepiece 201 shown in FIG. 4, the restriction protrusions are formed on the dial 202 and the hour indication plate 203, respectively. The restriction protrusions may be formed on at least one of the dial and the indication plate. For example, the restriction protrusion can restrict the tilting of the indication plate adjacent to an upper side (front side) of the dial 202 or the hour indication plate 203.

### Timepiece

### Fourth Embodiment

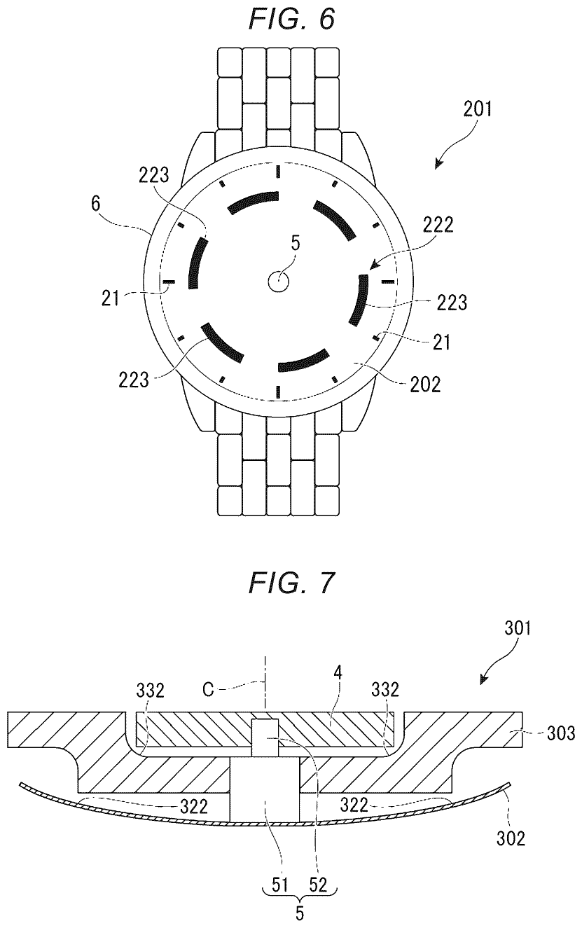

FIG. 7 is a schematic diagram showing a cross section of a dial 302 and indication plates 303 and 4 of a timepiece 301 according to a fourth embodiment. Components common to the other embodiments are denoted by the same reference numerals, and the description thereof is omitted.

As shown in FIG. 7, the timepiece 301 differs from the timepiece 1 (see FIG. 2) according to the first embodiment in that a first restriction portion 322 (restriction portion) is formed on the dial 302, and a second restriction portion 332 (restriction portion) is formed on the hour indication plate 303. The timepiece 301 may have the same configuration as the timepiece 1 (see FIG. 2) except for the first restriction portion 322 and the second restriction portion 332.

The first restriction portion 322 is formed at a position overlapping the hour indication plate 303 in the plan view. A height of the first restriction portion 322 is set to such an extent that the first restriction portion 322 does not reach the hour indication plate 303. When the hour indication plate 303 is tilted, the hour indication plate 303 comes into contact with the first restriction portion 322. Therefore, the first restriction portion 322 can restrict tilting of the hour indication plate 303.

The second restriction portion 332 is formed at a position overlapping the minute indication plate 4 in the plan view. A height of the second restriction portion 332 is set to such an extent that the second restriction portion 332 does not reach the minute indication plate 4. The second restriction portion 332 is positioned close to the outer peripheral edge of the minute indication plate 4. When the minute indication plate 4 is tilted, the minute indication plate 4 comes into contact with the second restriction portion 332. Therefore, the second restriction portion 332 can restrict tilting of the minute indication plate 4.

### Effects of Timepiece in Embodiment

The timepiece 301 according to the embodiment achieves the same effects as the timepiece 1 according to the first embodiment.

Further, in the timepiece 301, the tilting of the hour indication plate 303 can be prevented by the first restriction portion 322. The tilting of the minute indication plate 4 can be prevented by the second restriction portion 332. Therefore, postures of the hour indication plate 303 and the minute indication plate 4 can be stably maintained. Accordingly, when the user recognizes an indicator by touching the indicator with a finger, it is possible to prevent inaccuracy of an indication time (that is, a deviation of the indication time).

In the timepiece 301 shown in FIG. 7, the restriction portions are formed on the dial 302 and the hour indication plate 303, respectively. The restriction portions may be formed on at least one of the dial and the indication plate. For example, the restriction portion can restrict the tilting of the indication plate adjacent to an upper side (front side) of the dial 302 or the hour indication plate 303.

### Indicator

### First Example

FIG. 8A is a plan view of the indication plates 3 and 4 including a first example of the indicators 31 and 41. FIG. 8B is a side view of the hour indication plate 3.

As shown in FIGS. 8A and 8B, the hour indicator 31 is formed in a rectangular shape when viewed from the length direction thereof. The minute indicator 41 is also formed in a rectangular shape when viewed from the length direction thereof.

Since the hour indicator 31 and the minute indicator 41 are rectangular, an angle between the upper surface and the side surface thereof is small. Therefore, there is an advantage that it is easier to recognize by touching with a finger.

### Indicator

### Second Example

FIG. 9 is a side view of an hour indication plate 403 including an hour indicator 431 which is a second example of the hour indicator 31. Components common to the other examples are denoted by the same reference numerals, and the description thereof is omitted.

As shown in FIG. 9, the hour indicator 431 is formed in a trapezoid (specifically, an isosceles trapezoid) whose width gradually decreases in a protrusion direction thereof when viewed from the length direction thereof. A pair of side surfaces 431a of the hour indicator 431 are inclined, and approach each other as the protrusion height thereof increases. The side surfaces 431 a are chamfered.

Since the side surfaces 431a of the hour indicator 431 are inclined, when a user touches the hour indicator 431 with a finger, the finger is less likely to be locked. Therefore, a force in the circumferential direction applied to the hour indication plate 403 can be reduced. Accordingly, when the user recognizes an indicator by touching the indicator with a finger, it is possible to prevent inaccuracy of an indication time (that is, a deviation of the indication time).

### Indicator

### Third Example

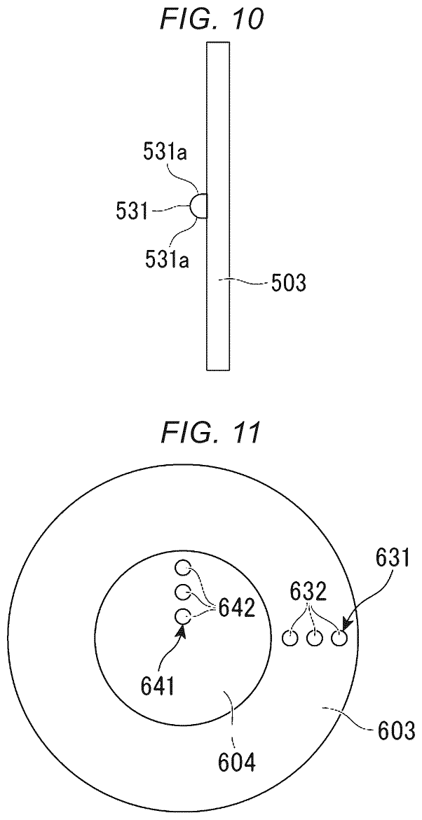

FIG. 10 is a side view of an hour indication plate 503 including an hour indicator 531 which is a third example of the hour indicator 31. Components common to the other examples are denoted by the same reference numerals, and the description thereof is omitted.

As shown in FIG. 10, the hour indicator 531 has a semicircular shape when viewed from the length direction thereof. Parts of a pair of side surfaces 53 1a of the hour indicator 531 are inclined, and approach each other as the protrusion height thereof increases. The side surfaces 531a are chamfered.

Since the side surfaces 531a of the hour indicator 531 are inclined, when a user touches the hour indicator 531 with a finger, the finger is less likely to be locked. Therefore, a force in the circumferential direction applied to the hour indication plate 503 can be reduced. Accordingly, when the user recognizes an indicator by touching the indicator with a finger, it is possible to prevent inaccuracy of an indication time (that is, a deviation of the indication time).

### Indicator

### Fourth Example

FIG. 11 is a plan view of indication plates 603 and 604 including indicators 631 and 641 which are a fourth example of the indicators 31 and 41. Components common to the other examples are denoted by the same reference numerals, and the description thereof is omitted.

As shown in FIG. 11, the hour indicator 631 includes a plurality of dot-shaped protrusions 632 arranged in the radial direction thereof.

The minute indicator 641 includes a plurality of dot-shaped protrusions 642 arranged in the radial direction thereof.

Since the indicators 631 and 641 are formed by the plurality of dot-shaped protrusions 632 and 642, when a user touches the indicators 631 and 641 with a finger, the finger is less likely to be locked. Therefore, a force in the circumferential direction applied to the indication plates 603 and 604 can be reduced. Accordingly, when the user recognizes an indicator by touching the indicator with a finger, it is possible to prevent inaccuracy of an indication time (that is, a deviation of the indication time).

### Timepiece

### Fifth Embodiment

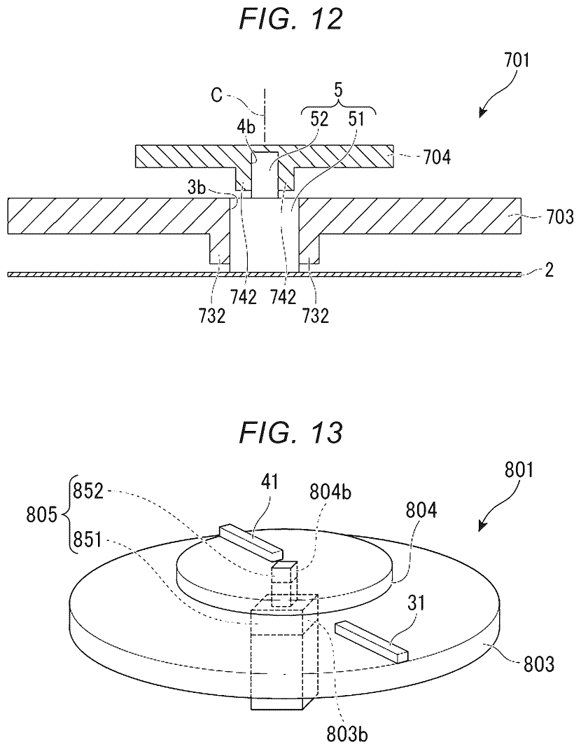

FIG. 12 is a schematic diagram showing a cross section of the dial 2 and indication plates 703 and 704 of a timepiece 701 according to a fifth embodiment. Components common to the other embodiments are denoted by the same reference numerals, and the description thereof is omitted.

As shown in FIG. 12, in the timepiece 701, a bearing tube portion 732 through which the first rotation shaft 51 is inserted is formed on the hour indication plate 703. The bearing tube portion 732 protrudes downward from a lower surface of the hour indication plate 703. An inner diameter of the bearing tube portion 732 is equal to an inner diameter of the fitting hole 3b.

A bearing tube portion 742 through which the second rotation shaft 52 is inserted is formed on the minute indication plate 704. The bearing tube portion 742 protrudes downward from a lower surface of the minute indication plate 704. An inner diameter of the bearing tube portion 742 is equal to an inner diameter of the fitting hole 4b.

In the timepiece 701, since the bearing tube portion 732 is formed on the hour indication plate 703, a frictional force between the first rotation shaft 51 and the hour indication plate 703 can be increased. Since the bearing tube portion 742 is formed on the minute indication plate 704, a frictional force between the second rotation shaft 52 and the minute indication plate 704 can be increased. Therefore, an attachment strength of the hour indication plate 703 and the minute indication plate 704 to the rotation shaft 5 can be increased. Accordingly, when the user recognizes an indicator by touching the indicator with a finger, it is possible to prevent inaccuracy of an indication time (that is, a deviation of the indication time).

### Timepiece

### Sixth Embodiment

FIG. 13 is a schematic perspective view showing the dial 2 and indication plates 803 and 804 of a timepiece 801 according to a sixth embodiment. Components common to the other embodiments are denoted by the same reference numerals, and the description thereof is omitted.

As shown in FIG. 13, in the timepiece 801, a rotation shaft 805 includes a first rotation shaft 851 and a second rotation shaft 852.

The first rotation shaft 851 has, for example, a rectangular tubular shape. The second rotation shaft 852 has, for example, a rectangular tubular shape coaxial with the first rotation shaft 851. The first rotation shaft 851 and the second rotation shaft 852 each have a non-circular cross section orthogonal to the length direction thereof. Specifically, the cross sections of the first rotation shaft 851 and the second rotation shaft 852 orthogonal to the length direction thereof are rectangular.

The first rotation shaft 851 is fitted into a fitting hole 803b of the hour indication plate 803. The fitting hole 803b has a rectangular shape conforming to the first rotation shaft 851 in the plan view. The second rotation shaft 852 is fitted into a fitting hole 804b of the minute indication plate 804. The fitting hole 804b has a rectangular shape conforming to the second rotation shaft 852 in the plan view.

### Method of Assembling Timepiece

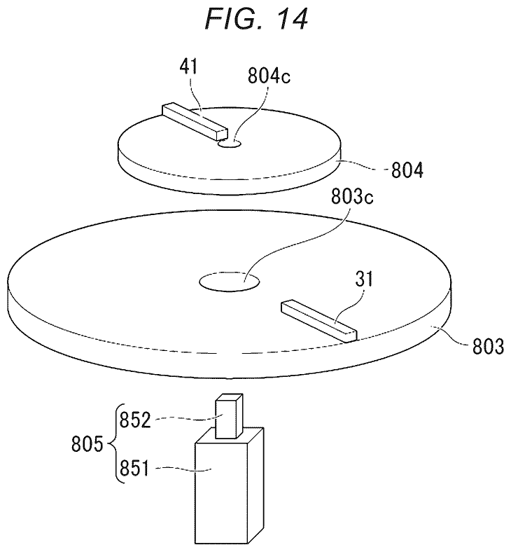

FIG. 14 is a schematic diagram showing a method of assembling the indication plates 803 and 804 of the timepiece 801.

As shown in FIG. 14, the first rotation shaft 851 is inserted into and fitted into a circular fitting hole 803c of the hour indication plate 803 by press. An inner diameter of the fitting hole 803c is smaller than a maximum outer dimension of the first rotation shaft 851. The fitting hole 803c becomes the rectangular fitting hole 803b (see FIG. 13) conforming to the first rotation shaft 851 by fitting the first rotation shaft 851 into the fitting hole 803c.

The second rotation shaft 852 is inserted into and fitted into a circular fitting hole 804c of the minute indication plate 804 by press. An inner diameter of the fitting hole 804c is smaller than a maximum outer dimension of the second rotation shaft 852. The fitting hole 804c becomes the rectangular fitting hole 804b (see FIG. 13) conforming to the second rotation shaft 852 by fitting the second rotation shaft 852 into the fitting hole 804c.

In the timepiece 801, for the indication plate 803, since the rotation shaft 851 having a non-circular cross section is press-fitted into the fitting hole 803b, an attachment strength of the hour indication plate 803 to the first rotation shaft 851 can be increased. For the indication plate 804, since the rotation shaft 852 having a non-circular cross section is press-fitted into the fitting hole 804b, an attachment strength of the minute indication plate 804 to the second rotation shaft 852 can be increased. Accordingly, when the user recognizes an indicator by touching the indicator with a finger, it is possible to prevent inaccuracy of an indication time (that is, a deviation of the indication time).

The invention is not limited to the embodiments described above with reference to the drawings, and various modifications are conceivable within the technical scope of the invention.

For example, in the embodiments, the timepiece includes the hour indication plate and the minute indication plate, but the number of indication plates is not particularly limited. For example, the number of indication plates may be one, or may be multiple (any number of two or more).

In the embodiment (see FIG. 1), the indexes 21, the hour indicator 31, and the minute indicator 41 are formed by the protrusion portions. However, the index, the hour indicator, and the minute indicator each may be formed by at least one of the protrusion portion and the recessed portion. For example, the index, the hour indicator, and the minute indicator each may be formed by the recessed portions, or may be formed by a combination of the protrusion portion and the recessed portion.

In the embodiment, the hour indication plate, the minute indication plate, and the indication region are provided to be vertically separated from one another, but the hour indication plate may be in contact with the indication region. The minute indication plate may be in contact with the hour indication plate.

In the embodiment (see FIG. 13), the cross sections of the rotation shafts 851 and 852 each have a rectangular shape. The shapes of the cross sections of the rotation shafts 851 and 852 each may be a non-circular shape. The shapes of the cross sections of the rotation shafts 851 and 852 each may be an elliptical shape, a polygonal shape (a triangular shape, or the like).

In addition, components in the above-described embodiments can be appropriately replaced with well-known components without departing from the gist of the invention.

What is claimed is:

1. A timepiece comprising:
a dial having an indication region that is able to be exposed to outside and including a plurality of indexes that are able to be recognized with a tactile sense on the indication region; and
one or more indication plates configured to rotate around a rotation shaft orthogonal to the indication region, wherein
an indicator indicating a time is formed on a front surface of the indication plate by unevenness that is able to be recognized by finger touch.

2. The timepiece according to claim 1, wherein
a plurality of the indication plates are provided, and
the plurality of indication plates include
an hour indication plate including, as the indicator, an hour indicator indicating an hour of the time, and
a minute indication plate including, as the indicator, a minute indicator indicating a minute of the time.

3. The timepiece according to claim 2, wherein
the hour indicator and the minute indicator are formed in a range in which the hour indicator and the minute indicator are able to be simultaneously recognized by finger touch with one finger.

4. The timepiece according to claim 1, wherein
at least one of the dial and the indication plate is formed with a protrusion for restricting tilting of the indication plate adjacent thereto.

5. The timepiece according to claim 1, wherein
at least one of the dial and the indication plate has a restriction portion, which is close to the indication plate adjacent thereto and which restricts tilting of the indication plate.

6. The timepiece according to claim 1, wherein
at least a part of a pair of side surfaces of the indicator is inclined so as to approach each other as a protrusion height thereof increases.

7. The timepiece according to claim 1, wherein
the indicator is formed by a plurality of dot-shaped protrusions.

8. The timepiece according to claim 1, wherein
a bearing tube portion through which the rotation shaft is inserted protrudes and is formed on the indication plate.

9. The timepiece according to claim 1, wherein
the rotation shaft has a non-circular cross section perpendicular to a length direction thereof, and
the indication plate has a fitting hole into which the rotation shaft is press-fitted.

10. The timepiece according to claim 1, wherein
the indication plate is formed in a circular plate shape concentric with the rotation shaft.
